(19) United States
(12) Patent Application Publication
(10) Pub. No.: US 2012/0266079 A1
(43) Pub. Date: Oct. 18, 2012

(54) USABILITY OF CROSS-DEVICE USER INTERFACES

(76) Inventors: Mark Lee, Saratoga, CA (US); Kay Chen, San Jose, CA (US); Yu Qing Cheng, San Jose, CA (US)

(21) Appl. No.: 13/449,161

(22) Filed: Apr. 17, 2012

Related U.S. Application Data
(60) Provisional application No. 61/476,669, filed on Apr. 18, 2011.

(51) Int. Cl. G06F 3/01; G06F 15/16; G06F 3/033

(52) U.S. Cl. 715/744

(57) ABSTRACT

Mechanisms are provided that improve the usability of remote access between different devices or with different platforms by predicting user intent and, based in part on the prediction, offering the user appropriate interface tools or modifying the present interface accordingly. Mechanisms for creating and using gesture maps that improve usability between cross-device user interfaces are also provided.

### CROSS REFERENCE TO RELATED APPLICATIONS

This patent application claims priority from U.S. provisional patent application Ser. No. 61/476,669, Splashtop Applications, filed Apr. 18, 2011, the entirety of which is incorporated herein by this reference thereto.

### BACKGROUND OF THE INVENTION

1. Technical Field

This invention relates generally to the field of user interfaces. More specifically, this invention relates to improving usability of cross-device user interfaces.

2. Description of the Related Art

Remote desktop and similar technologies allow users to access the interfaces of their computing devices, such as, but not limited to, computers, phones, tablets, televisions, etc. (considered herein as a “server”) from a different device, which can also be a computer, phone, tablet, television, gaming console, etc. (considered herein as a “client”). Such communication between the devices may be referred to herein as “remote access” or “remote control” regardless of the actual distance between devices. With remote access or remote control, such devices can be connected either directly or over a local or wide area network, for example.

Remote access requires the client to pass user interaction events, such as mouse clicks, key strokes, touch, etc., to the server. The server subsequently returns the user interface images or video back to the client, which then displays the returned images or video to the user.

It should be appreciated that the input methods that a client makes available to the user may be different from those assumed by the server. For example, when the client is a touch tablet and the server is a PC with a keyboard and a mouse, the input methods of touch tablet may be different from those of a PC with a keyboard and a mouse.

### SUMMARY OF THE INVENTION

Mechanisms are provided that improve the usability of remote access between different devices or with different platforms by predicting user intent and, based in part on the prediction, offering the user appropriate interface tools or modifying the present interface accordingly. Mechanisms for creating and using gesture maps that improve usability between cross-device user interfaces are also provided.

### BRIEF DESCRIPTION OF THE DRAWINGS

FIG. 1 is a schematic diagram of a remote session from a multi-touch enabled device to a remote computer or device over a wireless network, according to an embodiment;

FIG. 2 is a sample screenshot a screenshot of a Microsoft® Outlook application with scrolling and window controls magnified to enhance usability with a small screen client running an implementation of client application, e.g. Splashtop Remote Desktop by Splashtop Inc., according to an embodiment;

FIG. 3 is a sample screenshot of sample gesture hints for an iPad® tablet client device, by Apple Inc., according to an embodiment;

FIG. 4 is a sample screenshot of sample gesture profile hints for a Microsoft® PowerPoint presentation application context, according to an embodiment;

FIG. 5 is a sample screenshot of a selectable advanced game UI overlay associated with a game-specific gesture mapping profile, according to an embodiment; and

FIG. 6 is a block schematic diagram of a system in the exemplary form of a computer system according to an embodiment.

### DETAILED DESCRIPTION OF THE INVENTION

Mechanisms are provided that improve the usability of remote access between different devices or with different platforms by predicting user intent and, based in part on the prediction, offering the user appropriate interface tools or modifying the present interface accordingly. Also provided are mechanisms for creating and using gesture maps that improve usability between cross-device user interfaces.

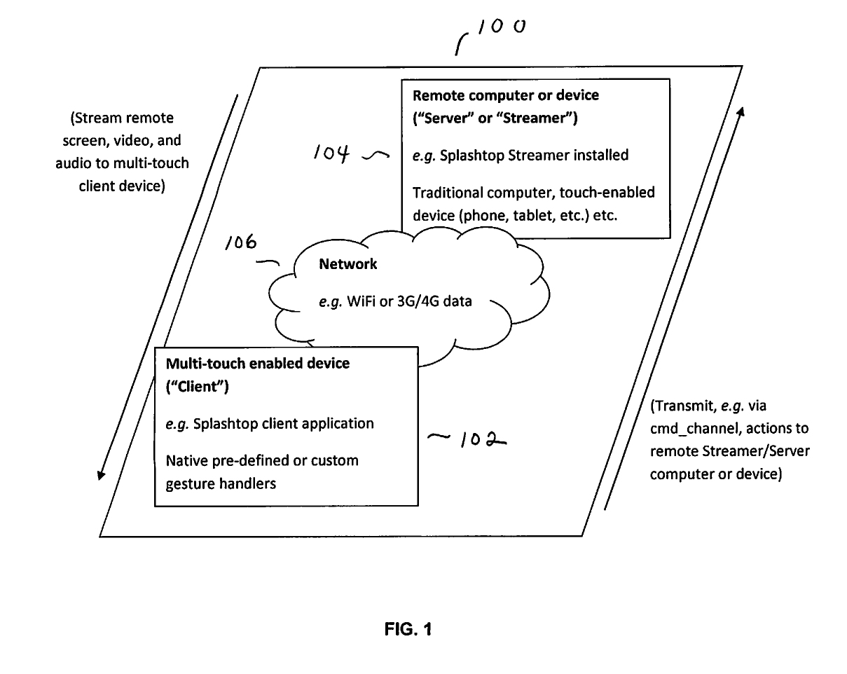

One or more embodiments can be understood with reference to FIG. 1. FIG. 1 is a schematic diagram of a remote session 100 between a client device 102 (“client”) and a remote computer or device 104 (“server”) over a wireless network 106, according to an embodiment. Referring to FIG. 1, in this particular embodiment, client 102 is a multi-touch enabled device 102, e.g. hosts Splashtop client application and contains native, pre-defined or custom gesture handlers. Server 104, in this particular embodiment, has Splashtop Streamer installed. Further, server 104 may be a traditional computer, touch-enabled, e.g. is a touch phone or tablet, and so on. Network 106, in this embodiment, may be transmit WiFi or 3G/4G data. Client 102 is further configured to transmit, e.g. via cmd_channel, actions to server 104 over wireless network 106. As well, server 104 is configured to stream remote screen, video, and audio to client device 102. A more detailed description of the above-described components and their particular interactions is provided hereinbelow.

### Predicitng User Intent and Offering User Interface Tools or Modifying the User Interface

### Method A: Predicting Need for Keyboard

One or more embodiments are discussed hereinbelow in which the need for a keyboard is predicted.

An embodiment for predicting the need for a keyboard can be understood by the following example situation, as follows: a user with a touch tablet, such as an iPad® (“client”), remotely accesses a computer (“server”) and uses a web browser on that computer. In this example, when the user taps on the address bar of the image of the computer browser, as displayed on the tablet, the user expects to enter the URL address. This action or input requires the tablet client to display a software keyboard to take user's input of the URL address.

However, normally, the client is not aware what the user tapped on as the actual web browser software is running on the server, not the client.

In one or more embodiments, the user intent may be predicted in several ways and such prediction may be used to bring up the software keyboard on the client. Such ways include but are not limited to the following techniques, used together or separately:
With several types of server operating systems, including but not limited to Microsoft® Windows (“Windows”) and Mac OS by Apple Inc. (“Mac OS”), it is possible to detect via programming techniques whether the current cursor displayed on the server corresponds to the text input mode, e.g. “I-beam cursor”. When the cursor changes to such text input mode cursor, it may be deduced that the user is about to input text. Examples of Application Programming Interfaces (APIs) used to determine the cursor mode can be found readily on the internet. For example, such APIs may be found at:

http://msdn.microsoft.com/en-us/library/ms648070(v=vs.85).aspx;
(for Windows); and
http://developer.apple.com/library/mac/#documentation/Cocoa/Reference/
ApplicationKit/Classes/NSCursor_Class/Reference/Reference.html
(for Mac OS).

When a user indicates, such as taps or clicks at, a particular point (“X”) on the user interface, common image processing algorithms may be used to determine if X is contained within an input field. For example, such algorithms may determine whether X is contained by a region bound by a horizontally and vertically aligned rectangular border, which is commonly used for input fields. Such technique may be considered as and used as a predictor of the intent of the user to input text. As another example, the bounding area representing an input field may have straight top and bottom edges, but circular left and right edges.
Detect the presence or appearance of a blinking vertical line or I-beam shape within the image of the remote user interface using common image processing algorithms and use such detection as a predictor of the user's intent to input text.

### Method B: Predicting Need for Magnification

One or more embodiments are discussed hereinbelow in which the need for magnification is predicted.

An embodiment for predicting need for magnification can be understood by the following example situation. In such example, a user is using a touch phone, such as an iPhone® by Apple Inc. (“client”) that has a small screen and remotely accesses a computer (“server”) that has a large or high resolution screen. The user commonly needs to close/minimize/maximize windows displayed by the server operating system, such as Windows or Mac OS. However, on the small client screen, those controls may be very small and hard to “hit” with touch.

One or more embodiments provided and discussed herein predict an intention of a user to magnify an image or window as follows. Such embodiments may include but are not limited to the following techniques, used together or separately:
Use common image processing algorithms on the client, on the server, or server OS APIs to detect positions of window edges, e.g. rectangular window edges. Knowing (which may require the server to pass this information to the client) common locations of window controls, e.g. but not limited to close/minimize/maximize window control buttons, relative to the application windows for a given type of the server, generously interpret user indications, e.g. clicks or touches, in the area immediately surrounding each control, but not necessarily exactly within it, as engaging the window control, e.g. window control button. Thus by an embodiment increasing the “hit” area, the embodiment may make it easier for the user to interact with fine controls. For purposes of discussion herein, increasing the “hit” area means that when someone makes an indication of interest, for example but not limited to taps/clicks, near a window control, the indication, e.g. tap, registers as an indication, for example such as a tap, on the window control. As an example of some of the zooming scenarios, a user may tap/click in an area with many words. If the contact area from a finger covers many words vertically and horizontally, then the action may zoom into that area. As another example, a tap of a user's finger around/near a hyperlink would suggest a desire to zoom in to that area so the user can tap on the hyperlink.
Provide dedicated controls for the current window, e.g. but not limited to close/minimize/maximize, and send corresponding commands to the server.
Provide magnified controls, e.g. but not limited to close/minimize/maximize each window, that either overlay the original controls or elsewhere in the interface.
Provide special key combination, gestures, or other inputs that send window control commands to the server. An example for a gesture mapping is for ctl+alt+del to be able to login to a Windows account. Other gestures needed are scrolling windows, such as our 2-finger drag up and down. Another common gesture to map is a swiping motion, such as our 2-finger swipe left and right to execute a “page up” or “page down” for changing slides in PowerPoint, Keynote, or Adobe files.

### Method C1: Predicting Need for Active Scrolling

One or more embodiments are discussed hereinbelow in which the need for active scrolling is predicted.

An embodiment for predicting need for active scrolling can be understood by the following example situation: a user with a touch phone, such as an iPhone®, (“client”) that has a small screen remotely accesses a computer (“server”) that has a large or high resolution screen and uses a web browser or an office application on that computer. As is common, a user may need to scroll within the window of such application. However, on the small client screen, the scroll bar and scrolling controls may be small and hard to hit or grab with touch.

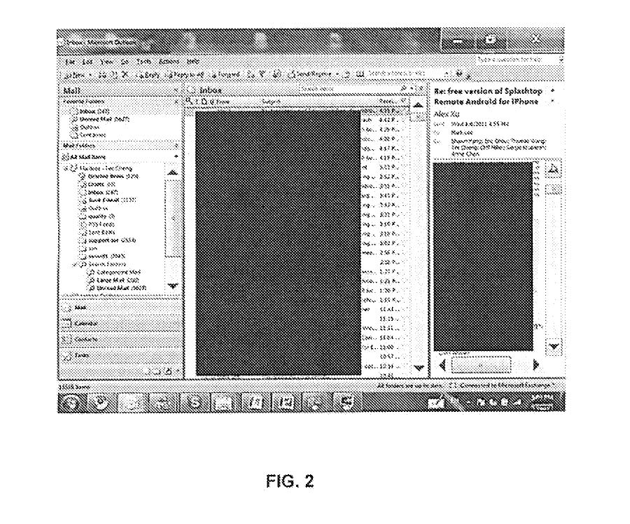

One or more embodiments provide improvements, such as but not limited to the following techniques, which can be used together or separately:
Use common image processing algorithms, either on the client or on the server or a combination thereof, to detect a scroll bar, e.g. a rectangular shape of a scroll bar, within the image of the user interface on the server. Knowing, which may require the server to pass this information to the client, the location of scroll bars and the respective controls of the scroll bar, e.g. the up/down controls that are above and below the scroll bars, generously interpret user clicks or touches in the area immediately surrounding the scroll bar or the controls, but not necessarily exactly within them, as engaging the corresponding control element. Thus increasing the hit area, the embodiment makes it easier for the user to interact with such fine controls. The above may refer to an example of using a finger on a tablet and trying to tap on a scroll bar, but “missing” it. An embodiment predetermines that the area tapped on has a scroll bar. Further, the embodiment creates an imaginary boundary around the scroll bar which may be but is not limited to two or three times the width of the scroll bar. Thus, for example, a tap to the left or right of the scroll bar and then dragging up and down is registered as a tap on the scroll bar and dragging up/down.
Provide dedicated magnified scrolling controls, either overlaying the original controls, elsewhere in the interface, or using the capabilities of the server OS. An embodiment may be understood with reference to FIG. 2. FIG. 2 is a sample screenshot of the Microsoft® Outlook application with scrolling and window controls magnified to enhance usability on a small screen client device. For example, such small screen client device may run Splashtop Remote Desktop client application. It should be appreciated that content of the email of FIG. 2 is deliberately blacked out because such content is not part of the illustration.

### Method C2: Predicting Need for Passive Scrolling

One or more embodiments are discussed hereinbelow in which the need for passive scrolling is predicted.

An embodiment for predicting need for passive scrolling can be understood by the following example situation: a user with a touch tablet, such as an iPad® (“client”), remotely accesses a computer (“server”), and uses an office application, such as Microsoft® Word® to type. Presently, when the location of the input happens to be in the lower half of the screen, that area of the client screen may be occupied by the software keyboard overlaid by the client on the image of the server screen.

One or more embodiments herein provide improvements that may include the following techniques, which may be used together or separately:
With several types of server operating systems, including but not limited to Windows and Mac OS, it is possible to determine, using programming techniques, the location of the cursor on the server and then pass this information to the client. When the software keyboard or another client-side user interface overlay is displayed and the cursor is below such overlay, the client, upon detecting that the cursor is below such overlay, may automatically shift the image of the server screen in a way such that the input cursor is visible to the user. For example, Windows or Mac OS may know where the focus of the text entry is and based in part on an embodiment pass such focus information to the tablet client. In accordance with the embodiment and based on the X and Y coordinate of the focus, the embodiment shifts the display so that the text entry is centered in the viewable area.
Detect the location of an input cursor, e.g. a blinking vertical line or I-beam shape, within the image of the remote user interface using common image processing algorithms executed either on the client or the server (in which case the cursor location information is then passed to the client), and shift the screen on the client as describe in the previous bullet point whenever the cursor location is obscured by the client user interface. For this case, on the client side, an embodiment performs image processing to locate a blinking I-beam and center the viewable area on such blinking I-beam. Thus, when the viewable area is reduced by a virtual keyboard, the embodiment also shifts the remote desktop screen so the I-beam location is centered in the viewable area.

### Method D: Predicting Need for Window Resizing

One or more embodiments are discussed hereinbelow in which the need for window resizing is predicted.

An embodiment for predicting need for window resizing can be understood by the following example situation: a user with a touch phone, such as an iPhone® (“client”) that has a small screen, remotely accesses a computer (“server”) that has a large or high resolution screen and uses a variety of window-based applications. As is common, the user may need to resize application windows. However, on the small client screen with touch, grabbing the edges or corners of the windows may be difficult.

Thus, one or more embodiments provide improvements to the above-described situation, but not limited to such situation, may include the following techniques, which may be used together or separately:
Use common image processing algorithms on the client, processing algorithms on the server, or server OS APIs to detect one or more positions of the boundaries of the application windows, e.g. rectangular window edges. Knowing the locations of the boundaries of the windows, e.g. window edges, which may require the server to pass this information to the client, generously interpret user clicks or touches in the area immediately surrounding the boundaries or window edges, but not necessarily exactly on them, as grabbing the corresponding boundary or edge. When such action is followed by a drag event, the windows are resized. Thus, increasing the hit area, the embodiment makes it easier for the user to interact with thin window boundaries, such as edges.
Provide dedicated magnified handles on window boundaries such as edges, one or more of which may either be overlaying or next to the edges of each window or the window in focus. For example, not all open windows may display handles, but, instead, only the window in focus may display such one or more handles.

### Method E: Predicting Application-Specific Control Needs

One or more embodiments are discussed hereinbelow in which application-specific control needs are predicted.

An embodiment for predicting application-specific control needs can be understood by the following example situation, which has similarities to Method C1 hereinabove, predicting the need for active scrolling described: there are application-specific controls, such as the browser back and forward navigation buttons, the usability of which may be improved by one or several of the following:
Use server OS, application-specific APIs, which are APIs on the server side that tells the location to the client side, or image recognition algorithms on the client or server to determine the locations of application specific controls, such as but not limited to the browser back and forward navigation buttons. Knowing the locations of such controls (which may require the server to pass this information to the client), generously interpret user clicks or touches in the area immediately surrounding such controls, but not necessarily exactly within them, to provide a larger hit area to the user.
Provide dedicated, e.g. magnified or otherwise highlighted or distinguished, controls on the client, duplicating or replacing the functionality of original controls, either as an overlay on the original control or elsewhere in the interface. The client application is configured for sending corresponding commands to the server.
Provide special key combination, gestures, or other inputs that send window control commands to the server. For example, a 4-finger swipe to the right could send the ‘go forward’ (Ctrl+RightArrow) or ‘next page’ (Page Down) command to the server application (browser, Word, Powerpoint, etc. . . . ), and a 4-finger swipe to the left could send the ‘go back’ (Ctrl+LeftArrow) or ‘previous page’ (Page Down) command to the server application.

### Method F: Modifying Input Behavior Depending on Client Peripherals

One or more embodiments are discussed hereinbelow for modifying input behavior based on client peripherals.

In an embodiment, it is considered that the usability improvements described above may or may not be necessary depending on the peripheral devices attached to the client. Such peripherals may include, but are not be limited to:
External keyboards connected over USB, Bluetooth® by Bluetooth SIG, Inc. (“Bluetooth”), and other methods;
External mouse devices;
External trackpad devices; and
External joystick or gamepad devices.

In an embodiment, the logic used to enable or disable the usability improvement methods described above incorporates conditional execution depending on the peripherals in use.

Thus, for example, if an external keyboard is attached to the client device, then the user may not need to use the keyboard on the display on the client, but, rather, use the external keyboard for typing text. Thus, in this example and for the purposes of understanding, conditional execution depending on the peripheral, i.e. keyboard, in use may include tapping on the “enable keyboard input” icon results in displaying an on-screen keyboard on the client device screen when there is no external keyboard peripheral connected to the client device. Whereas when there is a Bluetooth or other keyboard peripheral paired or connected to the client device, then tapping on the “enable keyboard input” icon would not display an on-screen keyboard, but rather just enable the peripheral keyboard's input to be sent in the control stream from client to Streamer.

### Method G: Offering Customizable Controls Via a Developer API/SDK

One or more embodiments are discussed for offering customizable controls via a developer Application Programming Interface (API) or a Software Development Kit (SDK).

One embodiment for improving usability of application interfaces delivered over a remote desktop connection allows third party developers to add their own custom user interface controls elements, such as virtual buttons or virtual joysticks, by using one or more APIs or an SDK made available by the remote desktop vendor to such third party developers. Thus, by programming such one or more APIs or SDK, developers may be allowed to add pre-defined or custom controls, such as but not limited to screen overlays or by integrating such controls within the application. Thus, an end user may have immediate access to such virtual control, such as button or joystick.

As well, by programming such one or more APIs or SDK, the remote desktop client may be notified that a particular type of controller is needed depending on the logic of the third party application. For example, an end user may bring up or invoke a virtual keyboard where some of the keys, e.g. F1-F12, are dedicated keys that are programmed by the third party to perform particular operations for the particular application, such as a virtual game.

In an embodiment, one or more APIs may be simple enough that typical end users may be able to customize some aspects of the controls. For instance, in a first-person Windows game, there may be a visual UI joystick overlay on the client device screen which controls the game player's directional and jumping movements. Not all Windows games however use the traditional ‘arrow keys’ or standard (A, W, S, D) keys to control directional movement. If the game has a different keyboard mapping or the user has customized their game environment to use different keys to control directional movement, a simple mapping/configuration tool or mode may be included in the Client application to map which keyboard stroke to send when each of the joystick's directional coordinates are invoked.

For example, consider a Windows game developer who is programming a game that uses four keyboard keys to navigate (A, W, S, D) and space bar to shoot. Because such game may be redirected to a remote tablet/phone with a touch interface, such developer may need to create a screen overlay having A, W, S, D and space-bar keys on the touch device. Such overlay may optimize the experience for the user, such as mapping virtual joysticks to these key interfaces. For instance up may be “W”, down “S”, left “A”, and right “D”.

For example, Splashtop Streamer by Splashtop Inc. may have an API/SDK to allow the game developer to add such a request-to-Splashtop for such screen overlay in accordance with an embodiment. In this example, the Splashtop Streamer notifies the Splashtop Remote client to overlay such keys at the client side.

In an embodiment, such overlay optionally may be done at the Streamer device side. However, it may be that a better user experience can be achieved when the overlay is done at the client side and, thus, both options are provided.

Thus, by such provided APIs at the Streamer or server side, application developers are empowered to render their applications as “remote” or “touch-enabled” when such applications would otherwise been targeted for traditional keyboard/mouse PC/MAC user environments.

It should be appreciated that one or more of the APIs/SDK may be readily found on the Internet or other networked sources, such as but not limited to the following sites:

http://msdn.microsoft.com/en-us/library/ms648070(v=vs.85).aspx;
(for Windows); and
http://developer.apple.com/library/mac/#documentation/Cocoa/Reference/
ApplicationKit/Classes/NSCursor_Class/Reference/Reference.html
(for Mac OS).

### Gesture Mapping for Improving Usability of Cross-Device User Interfaces

One or more embodiments for gesture mapping for improving usability of cross-device user interfaces is described with further details hereinbelow.

One or more embodiments may be understood with reference to FIG. 1. When using a multi-touch enabled device, which, for the purposes of discussion herein, may be a device without a physical full keyboard and mouse, as client 102 to access and control another remote computer or device, such as Streamer 104, it may be advantageous to provide a mechanism that maps the native input mechanisms of client device 102 to native actions or events on remote computer/device 104. For example, if otherwise, the stream is only one-way from Streamer 104 device to client device 102, then client device 102 may behave simply as a duplicate remote monitor for the remote computer. It should be appreciated that one drawback to this one-way traffic from Streamer to client device is that when the client user wants to control anything on the Streamer device, such user may need to be physically in front of the Streamer device's locally attached input peripherals and lose their ability to control the Streamer session remotely.

An important factor to take into consideration is that the native input mechanism of client device 102 often may not directly correlate to a native action on remote Streamer device 104 and vice-versa. Therefore one or more embodiments herein provide a gesture mapping mechanism between client device 102 and Streamer device 104.

For example, when client device 102 is a touch-screen client tablet that does not have a mouse input device attached, in accordance with an embodiment, a set of defined gestures for tablet 102 may be mapped to a set of mouse movements, clicks, and scrolls on a traditional mouse+keyboard computer, when server 104 is such computer.

Another example is when client 102 is an iPad® client device that uses a 2-finger pinch gesture, which are native to client device 102, to zoom in and out of a view. In an embodiment, such gesture may be mapped to a gesture of an Android Streamer device, which executes the 1-finger double-tap gesture to perform the correlating zoom in and out action, when server 104 is such Android Streamer device.

In addition, an embodiment may be configured such that client gestures that may be handled as native actions on the client device are handled on the client device, instead of being passed through a cmd_channel to the Streamer device to perform an action.

### Gesture Detection on Client and Action Handling on Streamer

On multi-touch client device 102, an embodiment provides gesture detection mechanisms for both pre-defined gestures as well as the ability to detect custom-defined gestures. For both of these cases, once a gesture is detected, client device 102 hosts one or more gesture handler functions which may directly send actions/events to Streamer 104 via the cmd_channel across network 106, perform a local action on client device 102, perform additional checks to see whether remote session 100 is in a certain specified state before deciding whether to perform/send an action, etc. For example, a custom gesture that is detected on the Client device may have a different mapping on the Streamer device depending on which application is in the foreground. Take the earlier example of 4-finger swipe to the right mapping to ‘go forward’ or ‘next page’. When the Streamer device receives this generic command, it should check whether the active foreground application is a web browser application, and execute the ‘go forward’ keyboard combination (Ctrl+RightArrow). On the other hand, when the Streamer device knows that the active foreground application is a document viewer, the Streamer device may instead execute the ‘next page’ keyboard command (PageDown).

In an embodiment, once client device 102 decides to send an action to Streamer device 104 through the cmd_channel over network 106, a defined packet(s) is sent over network 106 to Streamer 104. Such defined packet(s) translates the action message into low-level commands that are native to Streamer 104. For example, Streamer 104 may be a traditional Windows computer and, thus, may receive a show taskbar packet and translate such packet into keyboard send-input events for “Win+T” key-presses. As another example, when Streamer 104 is a traditional Mac computer, Streamer 104 may likewise translate the same show taskbar packet into keyboard send-input events for “Cmd+Opt+D”.

An embodiment can be understood with reference to TABLE A, a sample gesture map between a multi-touch tablet client device and a remote PC Streamer device.

TABLE A
Multi-touch client
gesture

| | |
|---|---|
| | Streamer action (sent through cmd_channel) |
| 1-finger single tap | Mouse left-click (screen coordinates) |
| 1-finger double tap | Mouse left-double-click (screen coordinates) |
| 1-finger long hold | Mouse right-click (screen coordinates) |
| 1-finger drag/pan | Mouse left-hold-and-drag (screen coordinates, |
| | movement differentials) |
| 2-finger single tap | Mouse hover (screen coordinates) |
| 2-finger drag/pan | Mouse scroll |
| 2-finger flick right/left | Next/previous page (for example in web browser |
| | or powerpoint presentation) |
| 1-finger flick | Switch monitor for video stream (for multi- |
| | monitor Streamer configs) |
| 2-finger twist/rotate | Toggle streaming video resolution and framerate |
| | quality (smooth/sharp mode) |
| 4-finger flick up/down | Show/hide taskbar or application dock (execute |
| | keyboard shortcut) |
| | Local client action (not sent through |
| | cmd_channel) |
| 3-finger single tap | Show/hide advanced control menu (for |
| | additional actions) |
| 5-finger pinch | Close remote session and return to available |
| | Streamer computers list |

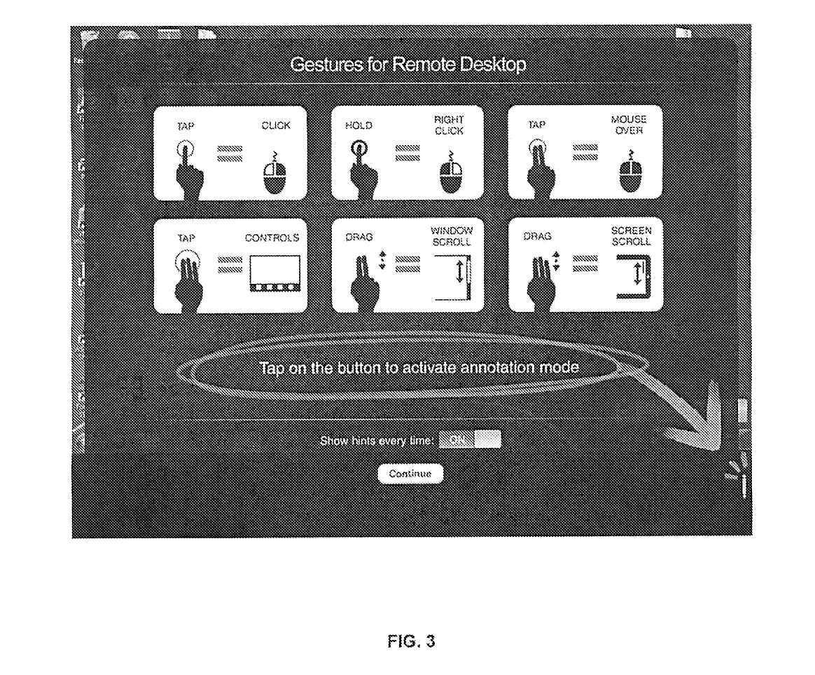

As well, an embodiment can be understood with reference to FIG. 3. FIG. 3 is a sample screenshot of sample gesture hints for an iPad® tablet client device, by Apple Inc., according to an embodiment. For example, FIG. 3 shows in the upper left image that a single finer tap is mapped to a right mouse click. As another example, the bottom middle image shows that a two-finger drag is mapped to a window scroll event.

### Advanced Multiple Mapping Profiles

In an embodiment, a plurality of mapping profiles is provided. For example, in an embodiment, a user may configure particular settings and preferences for one or more different mapping profiles that the user may have defined. Thus, depending upon such settings in the user's preferences, the user may be able to select from one of the user's gesture mapping profiles that is defined to allow the user to choose between a) remotely accessing and controlling a Streamer device using the client device's native gesture set and input methods or b) using a client device to access and control a Streamer device using the Streamer device's native gesture set and input methods. For example, client device 102 is an Apple touch-screen phone and Streamer device 104 is an Android touch-screen tablet, the user may select between controlling the remote session by using Apple iPhone's native gesture set or by using the Android tablet's native gesture set.

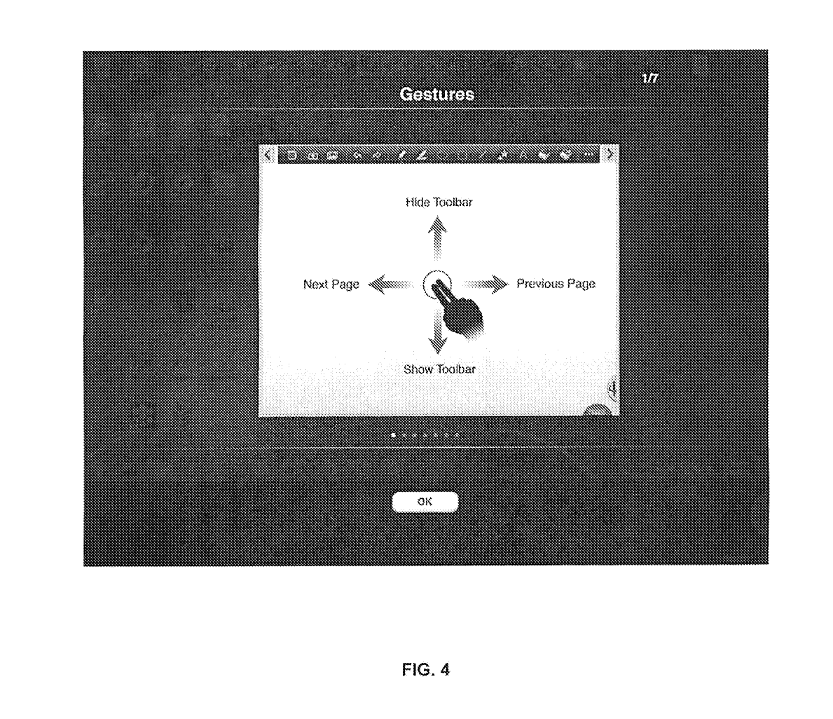

Another beneficial use case implementation for multiple selectable mapping profiles is application context-specific. For instance, a user may want to use one gesture mapping profile when they are controlling a PowerPoint presentation running on Streamer device 104 from touch-enabled tablet client device 102. In an embodiment, gesture mappings to control the navigation of the slide deck, toggle blanking of the screen to focus attention between the projector display and the speaker, enable any illustrations in the presentation, etc., are provided. An embodiment can be understood with reference to FIG. 4. FIG. 4 shows sample gesture profile hints for a PowerPoint presentation application context. For example, two-fingers dragged up correlate to hiding the toolbar. As another example, two-fingers dragged to the right moves the instant page to the previous page.

As another example, when the application being run is a first-person shooter game, then a new and different set of gestures may be desired. For example, for such game, a user may flick from the center of the screen on client 102 in a specified direction and Streamer 104 may be sent the packet(s)/action(s) to move the player in such direction. As a further example, a two-finger drag on the screen of client 102 may be mapped to rotating the player's head/view without affecting the direction of player movement.

Advanced Gesture Mapping in Conjunction with UI Overlays

In an embodiment, multiple selectable mapping profiles may also be used in conjunction with user interface (UI) overlays on client device 102 to provide additional advanced functionality to client-Streamer remote session 100. For example, for a game such as Tetris, perhaps an arrow pad on the client display may be overlaid on remote desktop screen image from the Streamer to avoid needing to bring up the on-screen keyboard on client device 102, which may obstruct half of the desktop view.

In an example of a more complex first-person shooter game, an embodiment provides a more advanced UI overlay defined for enabling player movement, fighting, and game interaction. Thus, for example, when discrete or continuous gestures are detected on client multi-touch device 102, then such gestures may be checked for touch coordinates constrained within the perimeters of the client UI overlay “buttons” or “joysticks” to determine which actions to send across the cmd_channel to Streamer device 104. For instance, there may be an arrow pad UI overlay on the client display which can be moved onto different areas of the screen, so as not to obstruct important areas of the remote desktop image. The client application may detect when a single-finger tap is executed on the client device, then check whether the touch coordinate is contained within part of the arrow pad overlay, and then send the corresponding arrow keypress to the Streamer. When the touch coordinate is not contained within the arrow paid overlay, the client application may send a mouse click to the relevant coordinate of the remote desktop image instead. Because typically first-person shooter games, MMORPGs, etc. have unique control mechanisms and player interfaces, the client UI overlays and associated gesture mapping profiles may be defined specifically for each game according to an embodiment. For example, to achieve a more customizable user environment, an embodiment may provide a programming kit to the user for the user to define his or her own UI element layout and associated gesture mapping to Streamer action.

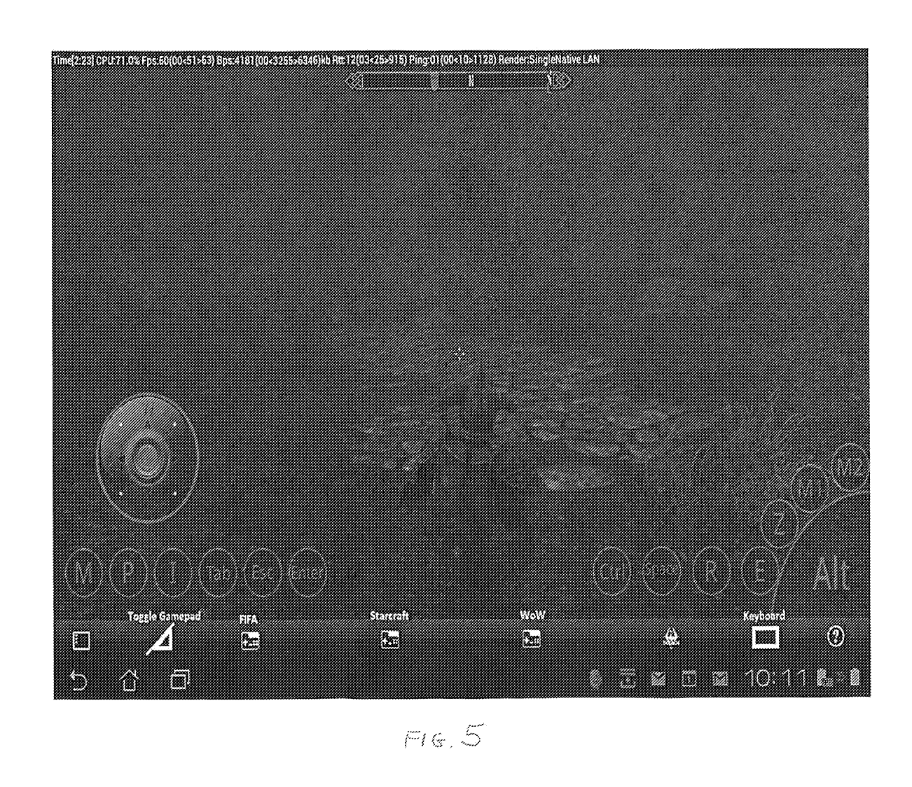

An embodiment can be understood with reference to FIG. 5. FIG. 5 shows a selectable advanced game UI overlay that is associated with game-specific gestures as discussed hereinabove.

### An Example Machine Overview

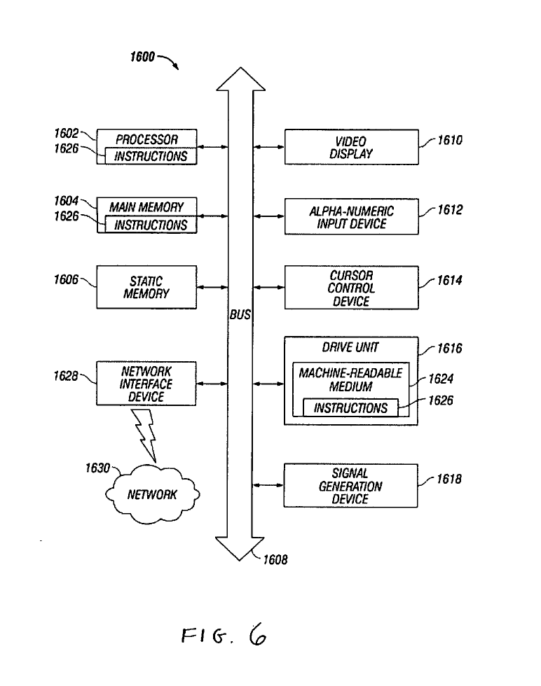

FIG. 6 is a block schematic diagram of a system in the exemplary form of a computer system 1600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for improving usability of cross-device user interfaces, comprising:
a server configured for being in a remote session with a client device;
said server configured for having at least one user interface that is used in said remote session;
said server configured for receiving at least one user interaction event from said client device wherein the user interaction event is intended for said user interface;
said server configured for predicting a user intent based in part on said received user interaction event and in response to receiving said user interaction event; and
said server configured for offering a corresponding user interface tool to be used with said user interface or for modifying said user interface in response to said predicted user intent.

2. The apparatus of claim 1, wherein said predicted user intent from the set of predicted user intents, the set comprising:
predicting need for a keyboard;
predicting need for magnification;
predicting need for active scrolling;
predicting need for passive scrolling;
predicting need for window resizing; and
predicting application-specific control needs.

3. The apparatus of claim 2, further comprising:
said server or said client being further configured for determining whether particular peripheral devices are attached to said client;
a processor comprising logic that is used to disable said predicting a user intent and subsequent offering a corresponding user interface tool or modifying said user interface, said disabling based in part on said logic determining that a peripheral device is attached to said client.

4. The apparatus of claim 1, further comprising:
a processor configured for offering customizable controls via a developer Application Programming Interface (API) or Software Development Kit (SDK).

5. The apparatus of claim 2, wherein predicting need for a keyboard uses at least one technique from the set of techniques comprising:
using APIs to determine a cursor mode;
using image processing algorithms to determine whether a particular point on said user interface is within an input field; and
using image processing algorithms to detect a presence or an appearance of a blinking vertical line or I-beam shape within an image on said user interface.

6. The apparatus of claim 2, wherein predicting need for magnification uses at least one technique from the set of techniques comprising:
using image processing algorithms to detect positions of window edges and to know locations of window controls of said windows, detecting user indications in a predetermined area around any of said window controls, and generously interpreting said indications as engaging said window control;
providing dedicated controls for each window, wherein when interacted with causes corresponding commands to be sent to said server;
providing magnified controls for each window that either overlay original controls or overlay elsewhere on the user interface; and
providing special key combination, gestures, or other inputs that cause window control commands to be sent to said server.

7. The apparatus of claim 2, wherein predicting need for active scrolling uses at least one technique from the set of techniques comprising:
using image processing algorithms to detect a scroll bar within an image of said user interface and knowing location of scroll bars and respective controls thereof, interpreting user clicks or touches in a predefined area surrounding the scroll bar or the controls as engaging a corresponding control element; and
providing dedicated magnified scrolling controls for overlaying original controls or for overlaying elsewhere in said user interface.

8. The apparatus of claim 2, wherein predicting need for passive scrolling uses at least one technique from the set of techniques comprising:
using an operating system of said server, determining location information of a cursor on the user interface of said server and passing said location information to said client and when a client-side user interface overlay is displayed and the cursor is below such overlay, causing the client, upon detecting that the cursor is below such overlay, to automatically shift an image on the user interface to cause the cursor to be visible on said client; and
detecting a location of a cursor within an image of said user interface using image processing algorithms executed either on said client or said server and shifting the image on the user interface to cause the cursor to be visible on said client whenever the cursor location is obscured by the client user interface.

9. The apparatus of claim 2, wherein predicting need for window resizing uses at least one technique from the set of techniques comprising:
using image processing algorithms, detecting one or more positions of boundaries of an application window, knowing locations of said boundaries of the window, interpreting user clicks or touches in a predefined area surrounding said boundaries as grabbing a corresponding boundary or edge and when said interpreting is followed by a drag event, causing said window to be resized; and
providing dedicated magnified handles on window boundaries that each overlays or is next to an edge of a window, wherein when engages causes the window to be resized.

10. The apparatus of claim 2, wherein predicting application-specific control needs uses at least one technique from the set of techniques comprising:
using image processing algorithms to determine locations of application-specific controls and knowing locations of said application-specific controls, interpreting user clicks or touches in a predefined area surrounding said application-specific controls as engaging said application-specific controls; and
providing dedicated application-specific controls for overlaying original controls or for overlaying elsewhere in said user interface, wherein said dedicated application-specific controls duplicate or replace the functionality of said original controls; and
providing special key combination, gestures, or other inputs that cause window control commands to be sent to said server.

11. The apparatus of claim 4, wherein said customizable controls comprise any of virtual buttons or virtual joysticks and wherein said customizable controls are displayed as screen overlays or the programming of which is integrated into the corresponding user interface application.

12. The apparatus of claim 11, wherein customizable controls are programmed by third party vendors or by end-users.

13. A computer-implemented method for improving usability of cross-device user interfaces, comprising the steps of:
providing a server that is configured for being in a remote session with a client device;
providing one or more processors on said server;
providing a storage memory in communication with said server;
wherein said server is configured for having at least one user interface that is used in said remote session;
said server receiving at least one user interaction event from said client device wherein the user interaction event is intended for said user interface;
said server predicting a user intent based in part on said received user interaction event and in response to receiving said user interaction event; and
said server offering a corresponding user interface tool to be used with said user interface or modifying said user interface in response to said predicted user intent.

14. A computer-readable storage medium storing one or more sequences of instructions for improving usability of cross-device user interfaces, which instructions, when executed by one or more processors, cause the one or more processors to carry out the steps of the computer-implemented method of claim 13.

15. An apparatus for gesture mapping for improving usability of cross-device user interfaces, comprising:
a client device configured for being in a remote session with a server and configured for while in said remote session with said server, detecting, at said client device, a particular gesture;
said client device comprising at least one gesture map and one or more gesture handler functions that perform operations from a set of operations, the set comprising:
send an action associated with said particular gesture to said server;
perform a local action responsive to said particular gesture; and
perform additional checks to determine whether said remote session is in a particular state before deciding whether to perform any other operation.

16. The apparatus of claim 15, wherein once said client device decides to send an action to said server, said client is further configured to send a defined packet to said server, wherein said defined packet translates said action into low-level commands that are native to said server.

17. The apparatus of claim 15, wherein said client device further comprises a gesture map that maps gestures to actions and wherein said action associated with said particular gesture is determined from a particular gesture map on said client device.

18. The apparatus of claim 15, further comprising:
a plurality of gesture mapping profiles which that are definable and selectable by an end-user.

19. The apparatus of claim 18, wherein a first gesture mapping profile causes said client to remotely access and control said server by using a native gesture set and input methods on said client and a second gesture mapping profile causes said client to access and control said server by using a native gesture set and input methods on said server.

20. The apparatus of claim 17, wherein said gesture map is application context-specific such that the gestures map to navigations of a particular application.

21. The apparatus of claim 18, wherein said plurality of gesture mapping profiles are used in conjunction with user interface (UI) overlays on said client device to provide additional advanced functionality to said remote session.

22. The apparatus of claim 21, wherein a more advanced UI overlay of said user interface overlays is defined for enabling player movement, fighting, and game interaction.

23. The apparatus of claim 22, wherein when discrete or continuous gestures are detected on said client, then said gestures are checked for touch coordinates constrained within perimeters of said client UI overlay buttons or joysticks to determine which actions to send to said server.

24. The apparatus of claim 15, further comprising:
a programming kit for an end-user to define his or her own user interface element layout and associated gesture mapping actions to said server.

25. A computer-implemented method for gesture mapping for improving usability of cross-device user interfaces, comprising the steps of:
providing a client for being in a remote session with a server and configured for while in said remote session with said server, detecting, at said client device, a particular gesture;
providing for said client at least one gesture map and one or more gesture handler functions that perform operations from a set of operations, the set comprising:
send an action associated with said particular gesture to said server;
perform a local action responsive to said particular gesture; and
perform additional checks to determine whether said remote session is in a particular state before deciding whether to perform any other operation.

26. A computer-readable storage medium storing one or more sequences of instructions for gesture mapping for improving usability of cross-device user interfaces, which instructions, when executed by one or more processors, cause the one or more processors to carry out the steps of the computer-implemented method of claim 25.
